(19) United States
(12) Patent Application Publication
(10) Pub. No.: US 2015/0197152 A1
(43) Pub. Date: Jul. 16, 2015

(54) Velocity Control System

(71) Applicant: Enrique Chavez, Miami, FL (US)

(72) Inventor: Enrique Chavez, Miami, FL (US)

(21) Appl. No.: 14/155,862

(22) Filed: Jan. 15, 2014

(51) Int. Cl. B60K 31/00; G08G 1/0967; B60K 31/18

(52) U.S. Cl. CPC B60K 31/0058; B60K 31/18; G08G 1/096725; B60K 2031/0091

(57) ABSTRACT

Velocity Control System is an interactive process between GPS satellite and each vehicle, where the possible maximum speed developed for each car is controlled by satellite, using an electronic module described in this article. The allowed maximum speed will vary depending on location, time or particular situations, in an automatic way, or by voluntary action for the police department. With this invention, car accidents will be considerably reduced.

### BACKGROUND OF THE INVENTION

Speeding is one of the most prevalent factors contributing to traffic crashes. The economic cost to society of speeding-related crashes is estimated by National Highway Traffic Safety Administration (NHTSA) to be $40.4 billion per year. In 2009, speeding was a contributing factor in 31 percent of all fatal crashes, and 10,591 lives were lost in speeding-related crashes.

Data from US department of Transportation, (National Highway Traffic Safety Administration), from 2000 to 2009, shows statistical records that more than 10 thousands lives are lost annually due speeding-related crashes.

The total economic cost of crashes was estimated at $230.6 billion in 2000. Motor vehicle crashes cost society an estimated $7,300 per second. In 2000, the cost of speeding-related crashes was estimated to be $40.4 billion-$76,865 per minute or $1,281 per second.

Speeding reduces a driver's ability to steer safely around curves or objects in the roadway, extends the distance necessary to stop a vehicle, and increases the distance a vehicle travels while the driver reacts to a dangerous situation.

### SUMMARY OF THE INVENTION

In order to develop this invention there are some important requirements:
1. Each car should be equipped with a GPS navigation system, preferably a built in GPS, although there is not display to show the map in the car's dashboard.
2. The GPS data acquired by the vehicle's navigation system at each time, should include the maximum speed limit corresponding to the current road.
3. Design an electronic module (“Velocity Control Module—VCM”) which process the vehicle speed in each moment, and the allowed maximum velocity of current road, sending a limit speed signal to Engine Control Unit (ECU), with the final result of reducing or keeping the current velocity, or avoiding increase it.
4. Complete domain of the police department over GPS Satellite information, for temporarily changes of speed limit values for some sectors, of every road.

With those four requirements, there will be a sequence of steps to interactively control the velocity of all vehicles in every road, that will be following described:

As show in the FIG. 1, every sectors of the roads will include the speed limit value 1 and it will be acquired by the GPS navigation system. It may be, or may be not shown in the display map. In FIG. 1, these values are marked over round circles, in an example of how could be seen a display map in the Navigation System of a car.

In FIG. 2 is described the process of acquisition of maximum speed value allowed in a certain road, and its final result, as follow:
1. First at all, the GPS satellite 2 send information to vehicle navigation system 3 about the speed limit of the current road where is positioned the car 4 at each moment.
2. Navigation system provide the VCM (Velocity Control Module) 5 with this value.
3. The transmission controller 6 send information to VCM 5 about current vehicle speed.
4. The VCM 5 process these both input information (current speed and maximum speed allowed) and send a limitation in maximum speed develop by the car to the ECU 7.
5. This way the motor of the vehicle could work, until a maximum specific speed, although the driver try to accelerate the car.

In FIG. 3 is described the process of control of vehicle velocity by police department.

Every speed limit value of each road, acquired by the navigation system 8 through the GPS satellite 9 will keep fixed in most of the time for each sector of the road, except in the following cases, automatically or in a manual way, by the police department speed control center 10:
1. Automatically: Those streets in school zones, will change its speed limit to 15 mph, depending of the date, and time of the day, and will recover its default speed limit value, also automatically, when the speed school zone time finish.
2. Those sectors of the roads that will be need to change the speed limit due any police activity, like a car persecution, blocked area, etc. In these cases the allowed maximum velocity may be limit or reduced to 0 mph in extremely necessity.

In those previous cases, the change in maximum speed allowed value for the road in transit, received by the navigation system 8, will be send to the VCM 11, with the followed limitation to overpass this limit by the ECU 12 and motor's vehicle, although the driver would try to accelerate.

In FIG. 4, is described in particular what are the input and output signals of VCM 13:

### Input:

1. Change in the speed limit value of the road in transit, received by the navigation system 14.
2. Driver control of velocity through accelerator 15.
3. Current velocity of vehicle, received from the transmission control 16.

### Output:

1. Signal to ECU 17 to reduce velocity of the car, or avoid acceleration by the driver.
2. Sound or light signal to dashboard 18, to let the driver known of one of the following:
   a. The driver is trying to accelerate the car over allowed maximum speed.
   b. The allowed maximum speed level of current road is being changed, and the vehicle is over this limit, then the vehicle will begin to reduce velocity automatically until reach the maximum allowed velocity.
   c. The car begin to transit in a not recognized road, and the car is reducing its velocity automatically until reach 15 mph.

Any of those changes in the speed limit patron, automatic or manual by the police department speed control 19, sent to each car through GPS satellite 20, into the Navigation System 14, is processed by VCM 13. This way the possible maximum speed developed by the vehicle is limit to this value.

In the possible scenario where the navigation system 14 detect the car is driving out of a recognized road, the maximum speed limit will be automatically reduced to 15 mph by VCM. This will help the correct transit speed inside any parking lot, small neighborhood, or any other similar situation, also facilitating any police car persecution when the running car begin to drive out of the road.

The only cars that will not have this electronic features will be racing cars, police cars, ambulance, firefighters trucks, or any other important community service vehicles.

In the following paragraphs, illustrated by drawings, I will describe some examples of situations that could be presents and how VCM will work in each case with its final results, in controlling the maximum velocity developed by the car.

### Case A: FIG. 5:

The driver try to accelerate vehicle:
1. The VCM 21 compare the desired velocity with the allowed velocity of the current road (data received from the Navigation System 22).
2. If the desired velocity is greater than the allowed velocity 23, the ECU 24 change velocity of the motor until reach allowed velocity, sending a sound or light signal to dashboard 25 and let the driver known he is trying to overpass the speed limit of the road he is transiting.
3. If the desired velocity is equal to the allowed maximum velocity 26, the ECU 24 change velocity of the motor until desired.
4. If the desired velocity is lesser than the allowed velocity 27, the ECU 24 change velocity of the motor until desired.

### Case B: FIG. 6:

The driver keep same velocity of vehicle.
1. The VCM 28 receive input signal to keep same velocity.
2. VCM send signal to ECU 29 to keep same velocity.

### Case C: FIG. 7:

The driver reduce velocity of vehicle.
1. The VCM 30 receive input signal to reduce velocity.
2. VCM send signal to ECU 31 to reduce velocity until it is desired.

### Case D: FIG. 8:

The vehicle is transiting for a road where the speed limit change its value, increasing or decreasing it (example: school zone, any sector of road, any exit of expressway, or manual change of the speed limit by police department (similar as FIG. 3)):
1. Navigation System 32 send the new speed limit value of the current road to the VCM 33.
2. The VCM 33 compare current speed with the new allowed velocity.
3. If the current velocity is greater than the allowed velocity 34, then there is a signal sent to the ECU 35, to change velocity of the motor until reach maximum allowed velocity, sending a sound or light signal to dashboard 36 and let the driver known the vehicle is automatically changing velocity due a change in speed patron of the road. When the vehicle reach the allowed velocity, then the sound or light signal at dashboard deactivates.
4. If the current velocity equal the allowed velocity 37, the ECU 35 keep same velocity of the motor.
5. If the current velocity is lesser than the allowed velocity 38, the ECU 35 keep same velocity of the motor.

### Case E: FIG. 9:

The vehicle begins to travel out of a road defined in map by GPS (examples: grass at the side of the road, any parking lot, some neighborhood):
1. Navigation System 39 notify the VCM 40 the vehicle is out of a recognized road.
2. The VCM 40 change the allowed speed to 15 mph.
3. The VCM 40 send a signal to ECU 41 to decrease motor revolution to 15 mph, and a sound or light signal to dashboard 42, to let the driver know the car is automatically reducing velocity because it is out of a recognized road.
4. Finally, the motor reduce velocity until 15 mph.

### EFFECTS OF THE INVENTION

1. The accidents will be considerably reduced.
2. The death due accidents will be diminished.
3. There will be a reduction in economic cost to society of car crashes.
4. There will not be any vehicle that can overpass the speed limit for each road.
5. All cars will be obligated to reduced velocity when they are transiting through school zone, depending of date and time of the day.
6. The street bumper could be removed from some streets, making easier the transit in those areas.
7. There will be a better transit fluid in all road, due the diminish in car accidents, and the congestion that could probably appear after them.
8. It will facilitated the police activity in any specific situations, like car persecution, any necessity of an street blockage, etc.

### BRIEF DESCRIPTION OF THE DRAWINGS

FIG. 1: Example of a map in the GPS navigation System, showing the speed limit of some roads.

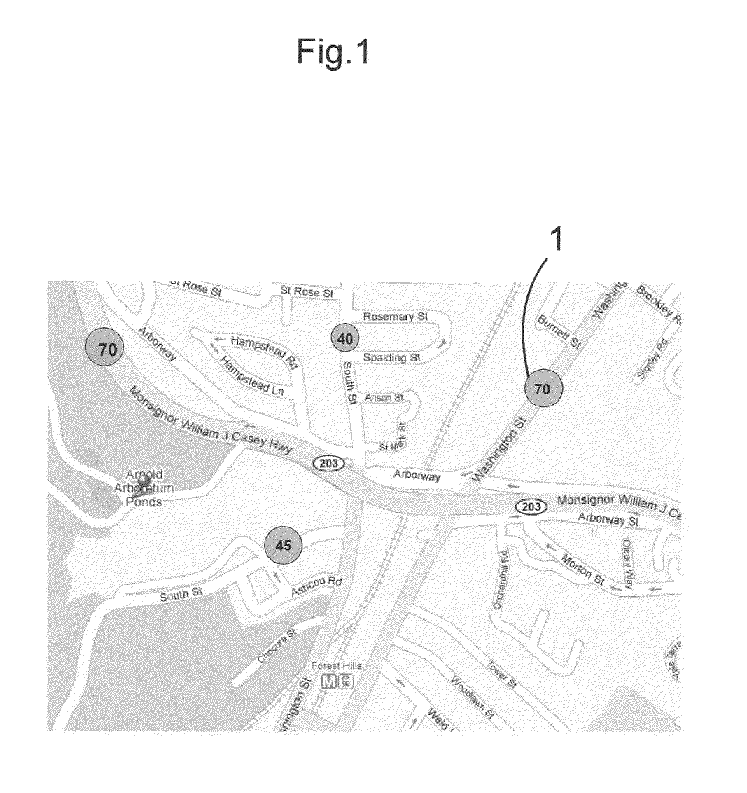

FIG. 2: Process of acquisition of maximum speed value allowed in a certain road, and its final result.

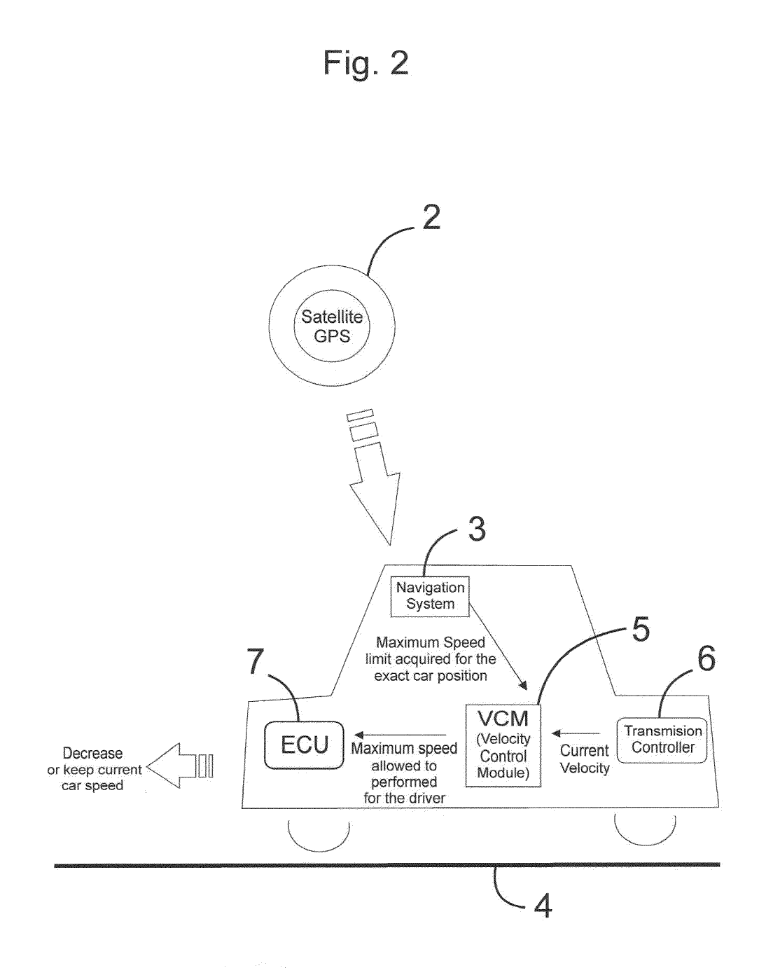

FIG. 3: Process of control of vehicle's velocity by police department.

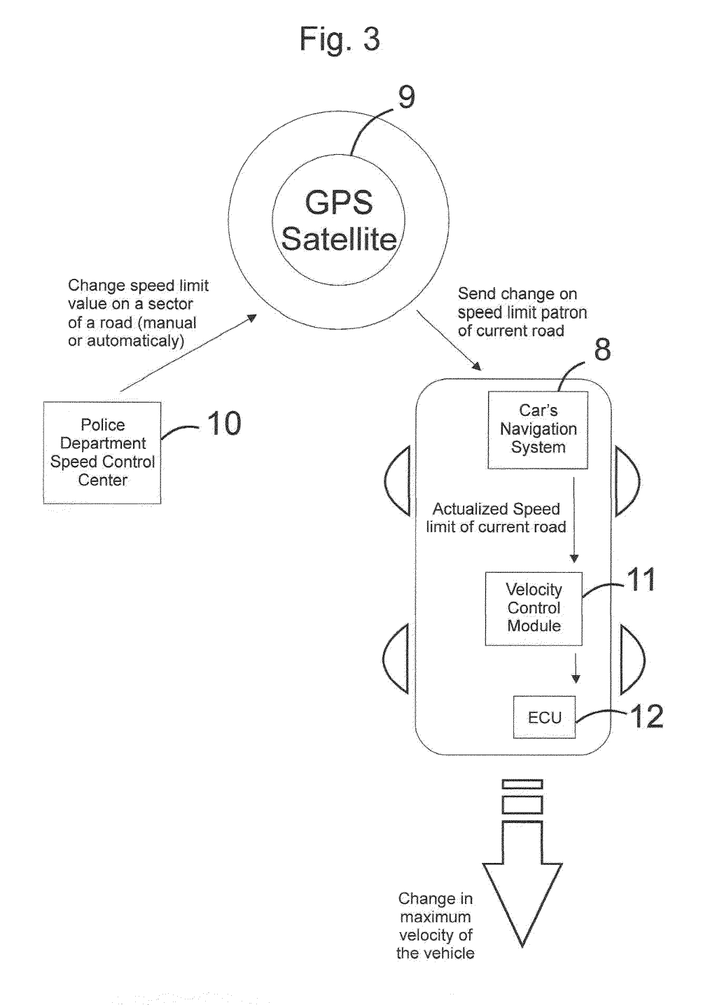

FIG. 4: Description of input and output signals of VCM (Velocity Control Module).

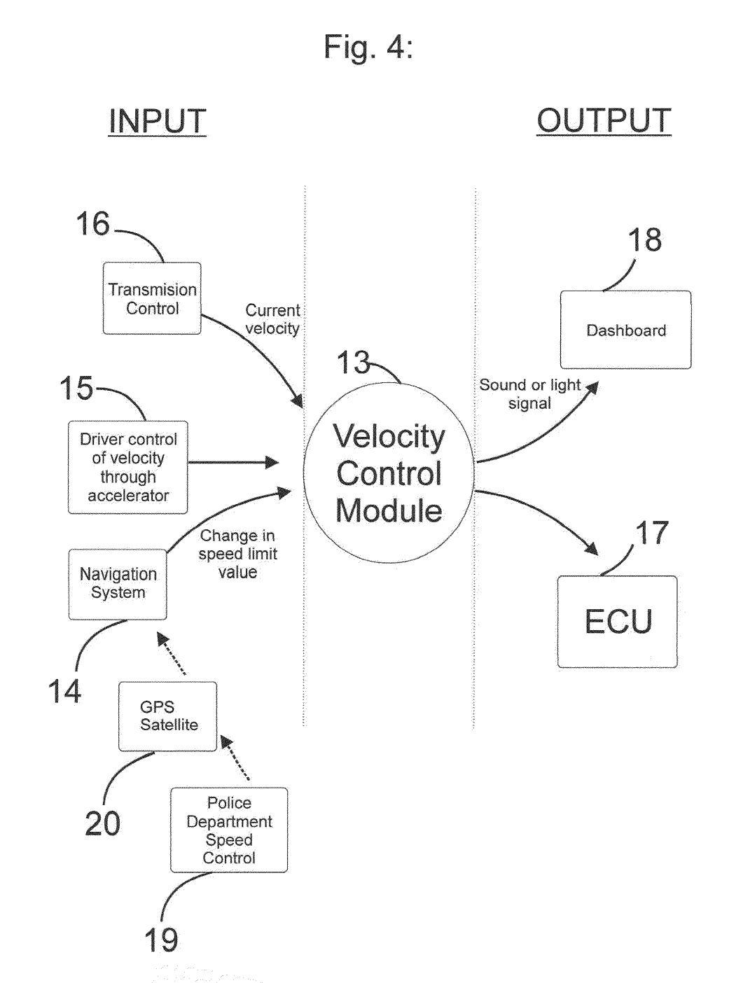

FIG. 5: CASE A: Schematic drawing of VCM work in case when driver try to accelerate vehicle.

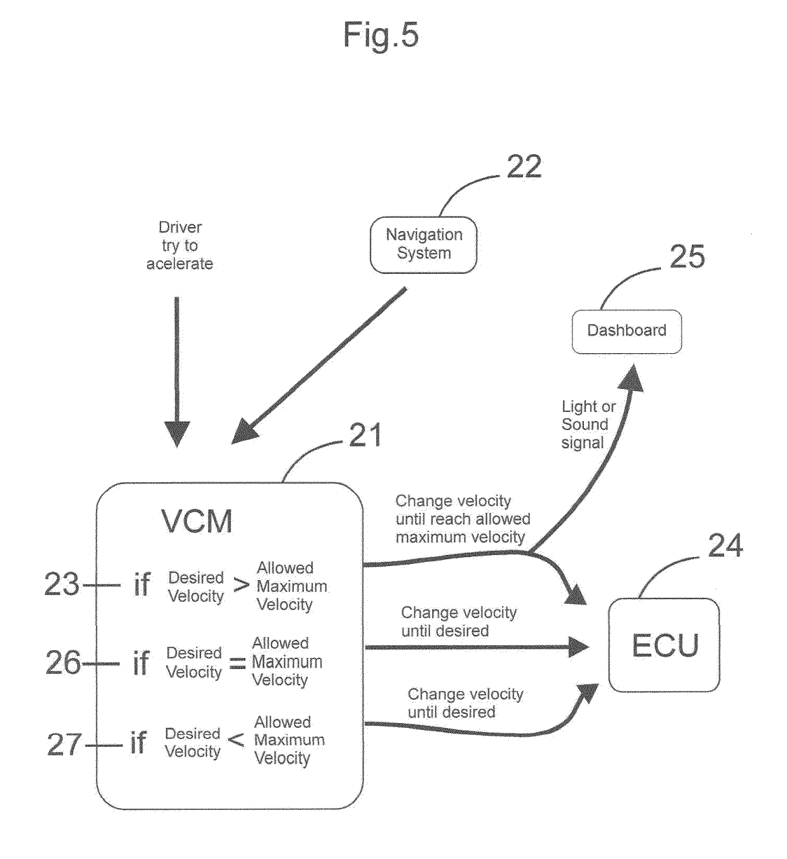

FIG. 6: CASE B: Schematic drawing of VCM work in case of driver keep same velocity of vehicle.

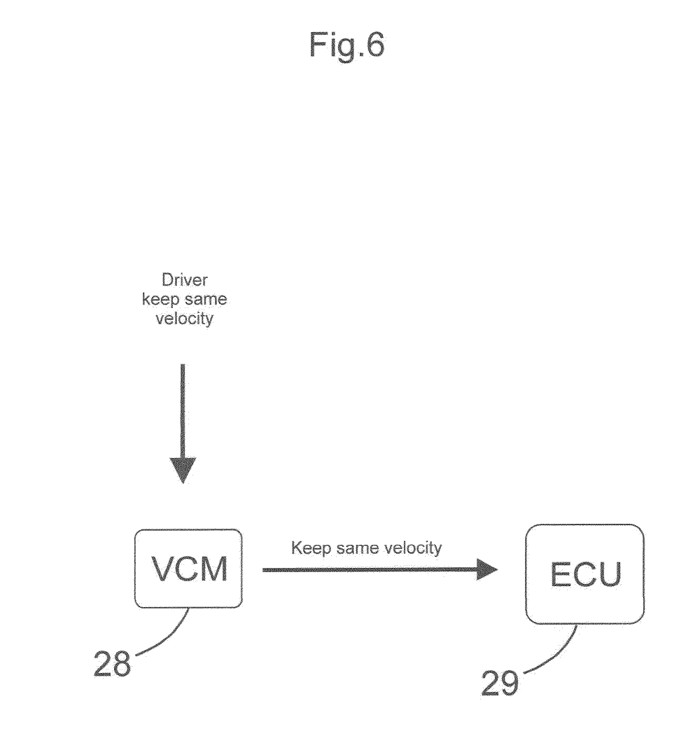

FIG. 7: CASE C: Schematic drawing of VCM work in case of driver reduces velocity of vehicle.

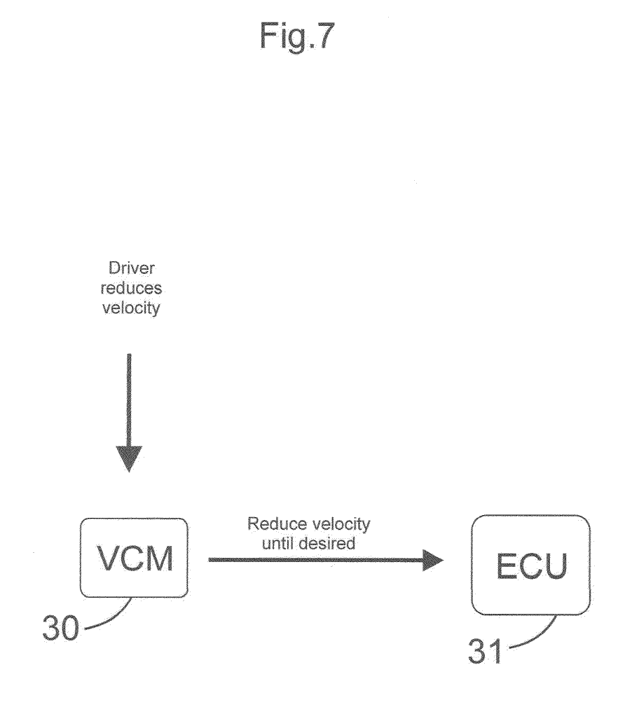

FIG. 8: CASE D: Schematic drawing of VCM work when the vehicle is transiting for a road where the speed limit change its value.

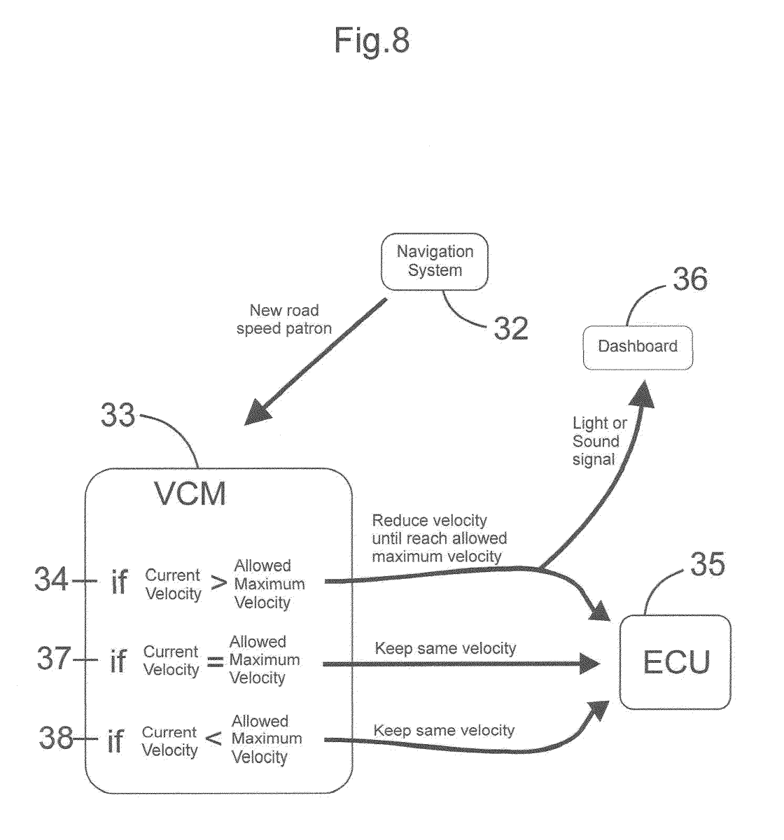

FIG. 9: Case E: Schematic drawing of VCM work when the vehicle begins to travel out of a road defined in map by GPS.

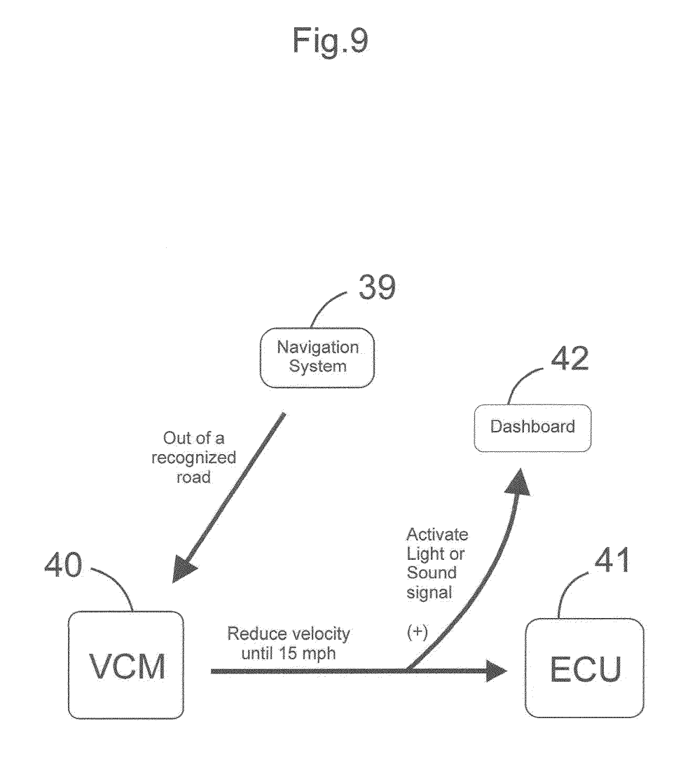

What is claimed is:

1. The GPS will have all data about speed limit of every road, in each of its sections or different areas, including local roads and expressways with its ramps and exits.

2. All data described in claim 1, will be collected by the navigation system of the vehicle, specifically the speed limit of the road where it is positioned the car at each moment. These data (speed limit of each sector of the roads), will keep fixed most of the time except in case of arguments of claim 3 and claim 4.

3. Some of the speed limit transferred to GPS signal will change its values automatically in scholar zones, depending of the date and time of the day (reducing to 15 mph in this case).

4. The police department could have control of varying the value of the speed limit of a road or a sector of it, by sending signal to GPS satellite in case of needed, including reducing to 0 mph and stop the transit, in case of great necessity.

5. There will be an electronic module called Velocity Control Module (VCM), which will evaluate the current vehicle speed and the allowed speed limit of the road in transit, and it will avoid the car (through the ECU) to overpass the allowed velocity of the road where it is traveling at each time, although the driver try to accelerate the motor of the car.

6. In case described in claim 5 (when driver accelerate over maximum allowed speed), there will be a sound or light signal at dashboard that will activate. This will also happen, when the velocity patron of the current road is being changed, and the car is automatically reducing velocity due this reason or when the vehicle begin to transit out of the road recognized by the GPS. In this last case, the VCM will take care of that, avoiding the motor of the vehicle to overpass 15 mph.
